(19) United States
(12) Patent Application Publication
(10) Pub. No.: US 2023/0030750 A1
(43) Pub. Date: Feb. 2, 2023

(54) Knife

(71) Applicants: HANGZHOU UNITED ELECTRIC MANUFACTURE CO., LTD., Hangzhou, Zhejiang (CN); HANGZHOU GREAT STAR INDUSTRIAL CO., LTD., Hangzhou, Zhejiang (CN)

(72) Inventor: Weiyi WANG, Hangzhou, Zhejiang (CN)

(21) Appl. No.: 17/790,512

(22) PCT Filed: Apr. 1, 2021
(86) PCT No.: PCT/CN2021/085007

§ 371 Date: Jul. 3, 2022

(30) Foreign Application Priority Data
Apr. 1, 2020 (CN) 202020461928.0

(51) Int. Cl. B26B 5/00; A22C 25/18

(52) U.S. Cl. CPC B26B 5/003; A22C 25/185

(57) ABSTRACT

Some embodiments of the present disclosure provide a knife. The knife includes a handle and a blade, the handle includes a first casing and a second casing that are detachably connected, the blade is clamped between the first casing and the second casing, the blade is provided with a plurality of limiting openings that are arranged horizontally, a limiting structure corresponding to the limiting openings is arranged on the handle, and the limiting structure has a locking position and an unlocking position; when the limiting structure is in the locking position, the blade is fixed on the handle; and when the limiting structure is in the unlocking position, the blade can move forward or backward relative to the handle.

### CROSS-REFERENCE TO RELATED APPLICATION

The disclosure is a national stage application of International Patent Application No. PCT/CN2021/085007, which is filed on Apr. 1, 2021, and claims a priority to Chinese Patent Application No. 202020461928.0, filed to the China National Intellectual Property Administration on Apr. 1, 2020 and entitled “Telescopic Knife”.

### TECHNICAL FIELD

The disclosure belongs to a technical field of knives, and in particular to a knife.

### BACKGROUND

Blades of common fish knives are non-removable, and different fish knives are suitable for different fish sizes. It is possibly unsafe to cut small fishes with large fish knives, while it is strenuous to cut large fishes with undersized fish knives. Thus, a plurality of fish knives are required for dealing with a variety of fishes of different sizes, resulting in inconvenience.

### SUMMARY

To solve problems in the art known to inventors, some embodiments of the present disclosure provide a knife, which aims to overcome a defect that a fish knife known to inventors is, not suitable for fishes of different sizes.

The disclosure is realized as follows:

The knife includes a holding part and a cutting part, where the cutting part is movably disposed on the holding part, the holding part is provided with a limiting structure, and the limiting structure has a locking position and an unlocking position; when the limiting structure is in the locking position, the cutting part is fixed on the holding part; and when the limiting structure is in the unlocking position, the cutting part is movably disposed relative to the holding part.

In some embodiments, the holding part is provided with an internal cavity, and one end of the cutting part is movably disposed in the internal cavity.

In some embodiments, the cutting part is provided with a plurality of limiting openings that are arranged horizontally, and the limiting structure matches the plurality of limiting openings so as to conduct locking or unlocking.

In some embodiments, the limiting structure includes a limiting sheet fixed in the holding part, and the limiting sheet is provided with a buckle that is configured to be embedded in each of the plurality of limiting openings; when the limiting structure is in the locking position, the buckle is embedded in one of the plurality of limiting openings; and when the limiting structure is in the unlocking position, the buckle is separated from the one of the plurality of limiting openings.

In some embodiments, the limiting structure further includes a lock catch movably disposed on the holding part, and the lock catch has a fixing position and an avoiding position; when the lock catch is in the fixing position, the lock catch is configured to fix the buckle in the one of the plurality of limiting openings; and when the lock catch is in the avoiding position, the buckle is configured of being separated from one of the plurality of the limiting openings.

In some embodiments, the limiting sheet is an elastic sheet, and when the limiting structure is in the unlocking position, the buckle is separated from the one of the plurality of limiting opening under an elastic force of the limiting sheet.

In some embodiments, the holding part is internally provided with a sliding groove, and the cutting part extends into the sliding groove and slides in the sliding groove when the limiting structure is, in the unlocking position.

In some embodiments, the holding part is internally provided with a blade carrier, and the sliding groove is provided on the blade carrier.

In some, embodiments, the limiting sheet is disposed on the blade carrier.

In some embodiments, the knife further includes a blocking structure, where the blocking structure is configured to limit a maximum travel of the cutting part relative to the holding part.

In some embodiments, a tail of the cutting part is provided with a limiting hook, the holding part or the blade carrier is provided with a blocking part, and when the cutting part extends out of the holding part to a maximum extent, the limiting hook is abutted against the blocking part.

In some embodiments, the limiting structure includes a locking member, the locking member is penetrated into the holding part, the locking member is configured to move relative to the holding part, the locking member is provided with an operation end, the operation end is located at an outer side of the holding part, the locking member is provided with a locking part, and the locking part is disposed corresponding to each of the plurality of limiting openings; when the limiting structure is in the unlocking position, the locking part is staggered from the plurality of limiting openings; and when the limiting structure is in the locking position, the locking part, is embedded in one of the plurality of limiting openings.

In some embodiments, the limiting structure includes a button protruding from the holding part, the button is provided with a locking rod penetrating the holding part, and the locking rod is provided with a locking block; when the limiting structure is in the unlocking position, the locking block is staggered from the plurality of limiting openings; and when the limiting structure is in the locking position, the locking block is embedded in the one of the plurality of limiting openings.

In some embodiments, an elastic member is disposed between the locking rod and the holding part, and an elastic force supplied to the locking rod by the elastic member makes the locking block be, embedded in the one of the plurality of limiting openings.

In some embodiments, each of the plurality of limiting openings is limiting groove with an opening.

In some embodiments, the limiting structure includes a locking member hanged with the holding part, and one end of the locking member is provided with a locking hook; when the limiting structure is in the unlocking position, the locking hook is separated from the plurality of limiting grooves; and when the limiting structure is in the locking position, the locking hook is embedded in one limiting groove.

In some embodiments, an elastic member is disposed between the locking member and the holding part, and an elastic force supplied to the locking member by the elastic member makes the locking hook be embedded in the one limiting groove.

In some embodiments, the elastic member is located at one end of the locking member away from the locking hook.

In some embodiments, each of the limiting grooves is of a toothed shape to form into a toothed groove.

In some embodiments, the locking hook includes a plurality of locking teeth matching toothed grooves corresponding to the plurality of limiting grooves.

In some embodiments, the holding part includes a handle, the cutting part includes a blade, the handle includes a first casing and a second casing that are detachably connected, and the blade is clamped between the first casing and the second casing.

The knife provided in the disclosure is capable of adjusting an extension length of the blade, so as to adapt to fishes of different sizes, and an application range of the knife is broadened.

### BRIEF DESCRIPTION OF THE DRAWINGS

The drawings of the description, which form a part of the disclosure, are used to provide further understanding of the present invention, and illustrative embodiments of the present invention and the description thereof are used to explain the present invention, which are not intended to unduly limit the present invention. In the drawings:

FIG. 1 illustrates a structural schematic diagram of a knife in Embodiment 1;

FIG. 2 illustrates a structural schematic diagram of a first section view of the knife in Embodiment 1;

FIG. 3 illustrates a structural schematic diagram of a section view when the knife is locked in Embodiment 1;

FIG. 4 illustrates a structural schematic diagram of a section view when the knife is unlocked in Embodiment 1;

FIG. 5 illustrates a structural schematic diagram of a second section view of the knife in Embodiment 1;

FIG. 6 illustrates a structural schematic diagram of a limiting sheet in the knife in Embodiment 1;

FIG. 7 illustrates a structural schematic diagram of a section view of the knife with a function of preventing separation of a blade in Embodiment 1;

FIG. 8 illustrates a structural schematic diagram of the blade of the knife with a function of preventing separation of a blade in Embodiment 1;

FIG. 9 illustrates a structural schematic diagram of a knife in Embodiment 2;

FIG. 10 illustrates a section view of an A-A direction in FIG. 9;

FIG. 11 illustrates a structural schematic diagram of a knife in Embodiment 3; and

FIG. 12 illustrates a structural schematic diagram of a knife in Embodiment 4.

### DESCRIPTION OF REFERENCE NUMERALS

100, handle; 110, first casing; 120, second casing; 130, blocking part; 140, elastic member; 200, blade; 210, limiting opening; 211, limiting groove; 212, toothed groove; 220, limiting hook; 300, blade carrier; 310, limiting sheet; 311, buckle; 320, lock catch; 321, locking face; 322, unlocking face; 330, sliding groove; 410, button; 420, locking rod; 430, locking block; 510, locking member; 511, locking hook; and 512, locking tooth.

### DETAILED DESCRIPTION OF THE EMBODIMENTS

The specific implementation of the disclosure will be further described in detail in combination with the accompanying drawings in the embodiments, so as to make the technical solution of the disclosure easier to understand and master. It should be understood that specific embodiments described herein are merely used to explain the disclosure, and are not used to limit the disclosure.

### Embodiment 1

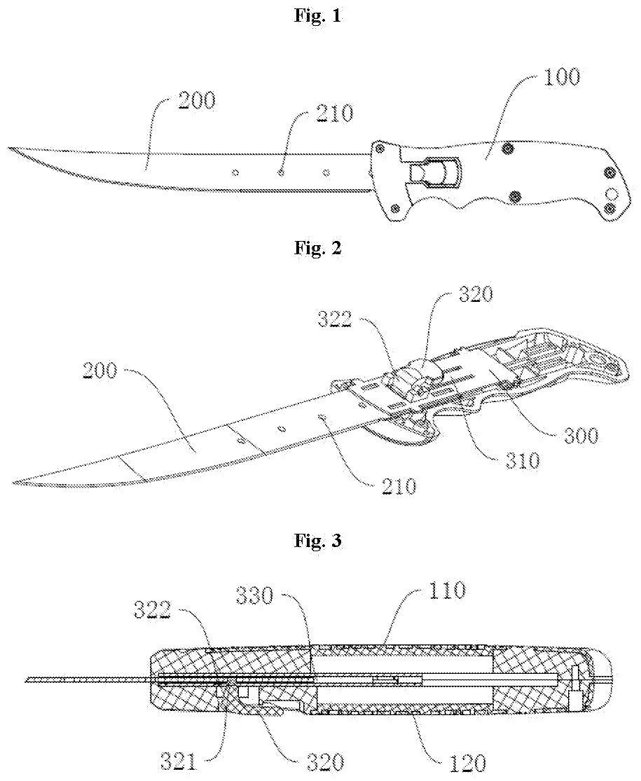

The Embodiment 1 provides a knife, which is used as a fish knife for cutting fishes. The knife specifically includes a cutting part and a holding part, where the cutting part is movably disposed on the holding part, the holding part is provided with a limiting structure, and the limiting structure has a locking position and an unlocking position; when the limiting structure is in the locking position, the cutting part is fixed on the holding part; and when the limiting structure is in the unlocking position, the cutting part is configured to move relative to the holding part, so that a position of the cutting part relative to the holding part is adjusted. As shown in FIGS. 1-6, the holding part includes a handle 100, the cutting part includes a blade 200, the handle 100 includes a first casing 110 and a second casing 120 that are detachably connected, the blade 200 is clamped between the first casing 110 and the second casing 120, the blade 200 is provided with a plurality of limiting openings 210 that are arranged horizontally, and the number of the plurality of limiting openings 210 is two or more, for example, five. The limiting openings 210 are groove structures or hole structures. In the embodiment 1, the hole structures are used, that is, a plurality of holes are provided in the middle of the blade 200 to serve as the limiting openings 210. The limiting structure corresponding to the limiting openings 210 is disposed on the handle 100, and the limiting structure has the locking position and the unlocking position; when the limiting structure is in the locking position, the blade 200 is fixed on the handle 100; and when the limiting structure is in the unlocking position, the blade 200 is capable of moving forward or backward relative to the handle 100.

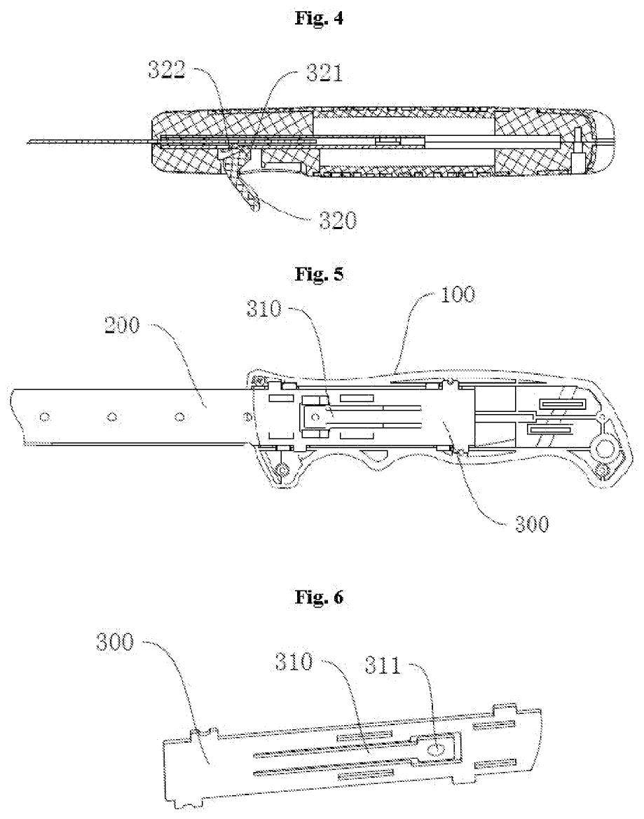

In the Embodiment 1, the limiting structure includes a limiting sheet 310 fixed in the handle 100 and a lock catch 320 movably disposed on the handle 100, the limiting sheet 310 is provided with a buckle 311 that is capable of being embedded in the limiting openings 210, and as long as the buckle 311 is capable of being fixed and avoided, the lock catch 320 is capable of rotating relative to the handle 100 and is also movably disposed relative to the handle 100. In the embodiment 1, the lock catch 320 is rotatably disposed on the handle 100; when the limiting structure is in the locking position, the lock catch 320 is abutted against the limiting sheet 310 to make the buckle 311 be embedded in one of the plurality of limiting openings 210; and when the limiting structure is in the unlocking position, a distance from the lock catch 320 to the blade 200 is larger than or equal to the sum of thicknesses of the limiting sheet 310 and the buckle 311. Switching between the locking position and the unlocking position of the limiting structure is realized by rotating the lock, catch 320. When the lock catch 320 is rotated to a position shown in FIG. 3, a locking face 321 of the lock catch 320 is abutted against the limiting sheet 310, so that the buckle 311 on the limiting sheet 310 is embedded in the one of the plurality of limiting openings 210, and the blade 200 is incapable of moving forward or backward under limiting of the buckle 311 so as to realize locking, that is, the limiting structure is in the locking position; and when the lock catch 320 is rotated to a position shown in FIG. 4, an unlocking face 322 of the lock catch 320 faces the limiting sheet 310, since a distance from the unlocking face 322 to the blade 200 is larger than or equal to the sum of the thicknesses of the limiting sheet 310 and the buckle 311, the buckle 311 is capable of moving toward the lock catch 320 and being separated from the one of the plurality of limiting openings 210, there may be a gap between the unlocking face 322 and the limiting sheet 310, or the unlocking face, may be attached to the limiting sheet. In this case, the limiting structure is in the unlocking position, and the blade 200 is capable of moving forward or backward relative to the handle 100 so as to adjust an extension length. After the extension length is adjusted in place, the limiting structure is returned to a locked state as shown in FIG. 3 by operating the lock catch 320.

The limiting sheet 310 is an elastic sheet, and when the limiting structure is in the unlocking position, the buckle 311 is separated from the one of the plurality of limiting opening 210 under an elastic force of the limiting sheet 310, so that smoothness of the blade 200 in a forward and backward movement process is improved, and a jamming phenomenon is reduced. In other optional embodiments, the buckle 311 is set in a cambered shape, and when the limiting structure is in the unlocking position, even if the limiting sheet 310 has no elasticity, the buckle 311 is separated from the limiting opening 210 by pushing and pulling the blade 200.

The handle 100 is internally provided with a sliding groove 330, the blade 200 extends into the sliding groove 330, and the blade 200 slides in the sliding groove 330 when the limiting structure is in the unlocking position. The blade 200 is guided by providing the sliding groove 330. In the embodiment 1, the sliding groove 330 is provided on the first casing 110 or the second casing 120, or both the first casing 110 and the second casing 120 are provided with sliding grooves 330.

As shown in FIGS. 2-5, the handle 100 is internally provided with a blade carrier 300, the blade carrier 300 is provided with the sliding groove 330, the blade 200 extends into the sliding groove 330 and slides in the sliding groove 330 when the limiting structure is in the unlocking position, and the limiting sheet 310 is, located on the blade carrier 300. The blade carrier 300 is of an integrated structure or a split, structure consisting of two carrier bodies. When the blade carrier 300 is the split structure, a gap between the two carrier bodies forms the sliding groove 330, and the limiting sheet 310 is located on one of the two carrier bodies.

The knife further includes a blocking structure, and the blocking structure limits a maximum travel of the blade 200 relative to the handle 100, so as to prevent the blade 200 from being separated from the handle 100. In the Embodiment 1, the blocking structure includes a first protruding part and a second protruding part, the first protruding part is disposed at a tail end of the blade 200, the second protruding part is disposed in the handle 100 accordingly and is arranged close to an end opening of the handle 100, and when the blade 200 extends out to realize maximum displacement, the first protruding part cooperates with the second protruding part to prevent the blade 200 from extending further.

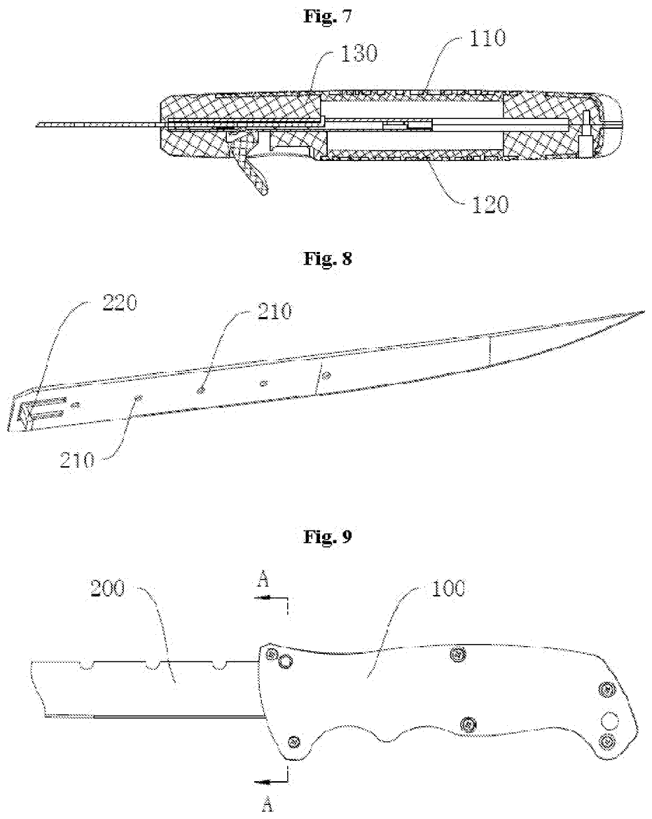

As shown in FIGS. 7-8, a tail of the blade 200 is provided with a limiting hook 220, the handle 100 is provided with a blocking part 130, and when the blade 200 extends out of the handle 100 to the maximum extent, the limiting hook 220 is abutted against the blocking part 130, so that the blade 200 is prevented from being separated from the handle 100. In other optional embodiments, the blocking part 130 is located on the blade carrier 300.

### Embodiment 2

A main difference between the embodiment 2 and Embodiment 1 is a limiting structure.

The limiting structure includes a locking member, the locking member penetrates into a handle 100, the locking member is capable of moving relative to the handle 100, the locking member is provided with an operation end, the operation end is located at, an outer side of the handle 100, the locking member is provided with a locking part, and the locking part is arranged corresponding to a limiting opening; when the limiting structure is in a unlocking position, the locking part is staggered from the plurality of limiting openings 210; and when the limiting structure is in an locking position, the locking part is embedded in one of the plurality of limiting openings 210.

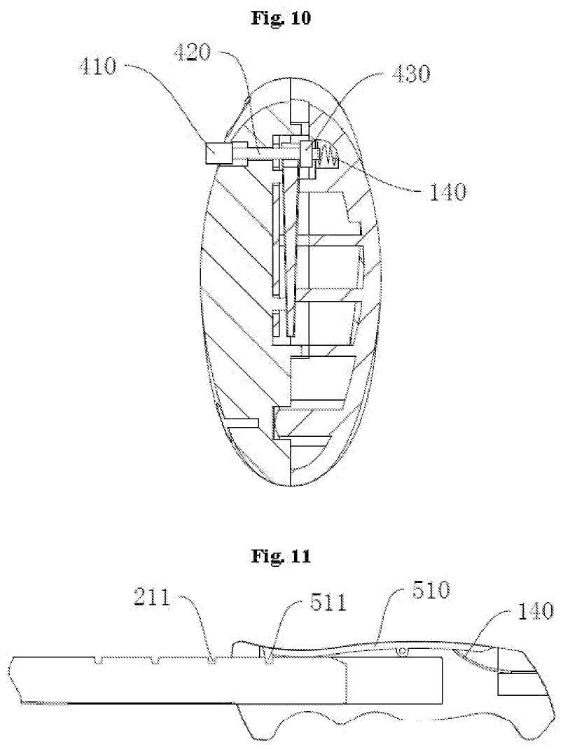

In the embodiment 2, as shown in FIGS. 9-10, the limiting structure includes a button 410 protruding from the handle 100, the button 410 is provided with a locking rod 420 penetrating the handle 100, and the locking rod 420 is provided with a locking, block 430; when the limiting structure is in the unlocking position, the locking block 430 is staggered from the plurality of limiting openings 210; and when the limiting structure is in the locking position, the locking block 430 is embedded in the one of the plurality of limiting openings 210. An elastic member 140 is disposed between the locking rod 420 and the handle 100, and an elastic force supplied to the locking rod 420 by the elastic member 140 makes the locking block 430 be embedded in the one of the plurality of limiting openings 210. The elastic member 140 is a spring.

When the button 410 is pressed, the locking rod 420 moves against the elastic force of the elastic member 140, and then drives the locking block 430 to move to be separated from the limiting opening 210. In this case, the limiting structure is in the unlocking position, and a blade 200 is capable of moving forward or backward relative to the handle 100. When the button 410 is released, the locking rod 420 moves under the elastic force of the elastic member 140, and then drives the locking block 430 to be embedded in the one of the plurality of limiting openings 210. In this case, the limiting structure is in the locking position, and the locking block 430 forms a constraint on the blade 200 in the limiting opening 210, so that the blade 200 is incapable of moving forward or backward.

Other structures and effects of the Embodiment 2 are consistent with those of Embodiment 1, which will not be repeated herein.

### Embodiment 3

A main difference between the embodiment and Embodiment 1 is a limiting structure.

In the Embodiment 3, as shown in FIG. 11, each of the plurality of limiting openings 210 is a limiting groove 211 with openings. In the embodiment 3, the openings of the limiting grooves 211 are upward, the number of the limiting grooves 211 is four, the limiting structure includes a locking member 510 hanged with a handle 100, and one end of the locking member 510 is provided with a locking hook 511; when the limiting structure is located in a locking position, the locking hook 511 is separated from the plurality of limiting grooves 211; and when limiting structure is in an unlocking position, the locking hook 511 is embedded in one limiting groove 211.

To improve a locking effect, an elastic member 140 is disposed between the locking member 510 and the handle 100, an elastic force supplied to the locking member 510 by the elastic member 140 makes the locking hook 511 be embedded in one the plurality of limiting grooves 211, and the locking hook 511 is separated from the one of the plurality of limiting grooves 211 by pressing or pulling the locking member 510. The elastic member 140 is an elastic piece.

The locking member 510 is partially exposed outside the handle 100 for operation, for example, a rear section of a joint where the locking member 510 is hanged with the handle 100 is exposed outside the handle 100. When the rear section is pressed, the locking member 510 makes one end with the locking hook 511 be tilted upward against swinging of the elastic member 140, and the locking hook 511 is separated from the one of the plurality of limiting grooves 211. In this case, the limiting structure is in the unlocking position, and the blade 200 is capable of moving forward or backward. After the rear section is released, under the elastic force of the elastic member 140, the locking hook 511 is embedded in the one of the plurality of limiting grooves 211. In this case, the limiting structure is in the locking position.

In other optional embodiments, the locking member 510 is disposed at a side of the handle 100, and the limiting openings 210 still is hole structures.

Other structures and effects of the Embodiment 3 are consistent with those of Embodiment 1, which will not be repeated herein.

### Embodiment 4

Differences between the embodiment and Embodiment 3 are structures of limiting openings 210 and a locking hook 511.

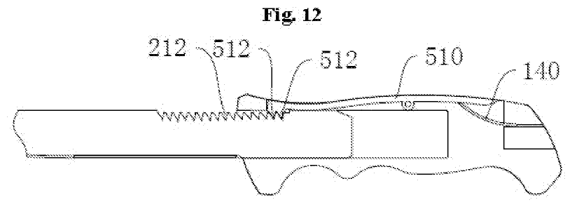

In this embodiment, as shown in FIG. 12, each of the plurality of limiting openings is a limiting groove, the limiting groove of a toothed shape to form into a toothed groove 212, toothed grooves 212 corresponding to the plurality of limiting grooves are continuously distributed, and a distance between the adjacent toothed grooves 212 is equivalent to a size of a toothed groove 212, so that fine adjustment of expansion and contraction of a blade 200 can be realized, and the knife can better adapt to fishes of different sizes. The locking hook 511 is locking teeth 512 matching the toothed grooves 212, and a locking member 510 is provided with two locking teeth 512 corresponding to two adjacent toothed grooves 212, so that locking is more stable.

Other structures and effects of Embodiment 4 are consistent with those of Embodiment 3, which will not be repeated herein.

What is claimed is:

1. A knife, comprising a holding part and a cutting part, wherein the cutting part is movably disposed on the holding part, the holding part is provided with a limiting structure, and the limiting structure has a locking position and an unlocking position; when the limiting structure is in the locking position, the cutting part is fixed on the holding part; and when the limiting structure is in the unlocking position, the cutting part is movably disposed relative to the holding part.

2. The knife as claimed in claim 1, wherein the holding part is provided with an internal cavity, and one end of the cutting part is movably disposed in the internal cavity.

3. The knife as claimed in claim 1, wherein the cutting part is provided with a plurality of limiting openings that are arranged horizontally, and the limiting structure matches the plurality of limiting openings so as to conduct locking or unlocking.

4. The knife as claimed in claim 3, wherein the limiting structure comprises a limiting sheet fixed in the holding part, and the limiting sheet is provided with a buckle that is configured to be embedded in each of the plurality of limiting openings; when the limiting structure is in the locking position, the buckle is embedded in one of the plurality of limiting openings; and when the limiting structure is in the unlocking position, the buckle is separated from the one of the plurality of limiting openings.

5. The knife as claimed in claim 4, wherein the limiting structure further comprises a lock catch movably disposed on the holding part, and the lock catch has a fixing position and an avoiding position; when the lock catch is in the fixing position, the lock catch is configured to fix the buckle in the one of the plurality of limiting opening; and when the lock catch is in the avoiding position, the buckle is configured to be separated from the one of the plurality of limiting openings.

6. The knife as claimed in claim 5, wherein the limiting sheet is an elastic sheet, and when the limiting structure is in the unlocking position, the buckle is separated from the one of the plurality of limiting openings under an elastic force of the limiting sheet.

7. The knife as claimed in claim 4, wherein the holding part is internally provided with a sliding groove, and the cutting part extends into the sliding groove and slides in the sliding groove when the limiting structure is in the unlocking position.

8. The knife as claimed in claim 7, wherein the holding part is internally provided with a blade carrier, and the sliding groove is provided on the blade carrier.

9. The knife as claimed in claim 8, wherein the limiting sheet is disposed on the blade carrier.

10. The knife as claimed in claim 1, further comprising a blocking structure, wherein the blocking structure is configured to limit a maximum travel of the cutting part relative to the holding part.

11. The knife as claimed in claim 8, wherein a tail of the cutting part is provided with a limiting hook, the holding part or the blade carrier is provided with a blocking part, and when the cutting part extends out of the holding part to a maximum extent, the limiting hook is abutted against the blocking part.

12. The knife as claimed in claim 3, wherein the limiting structure comprises a locking member, the locking member is penetrated into the holding part, the locking member is configured to move relative to the holding part, the locking member is provided with an operation end, the operation end is located at an outer side of the holding part, the locking member is, provided with a locking part, and the locking part is disposed corresponding to each of the plurality of limiting openings; when the limiting structure is in the unlocking position, the locking part is staggered from the plurality of limiting openings; and when the limiting structure is in the locking position, the locking part is embedded in one of the plurality of limiting openings.

13. The knife as claimed in claim 3, wherein the limiting structure comprises a button protruding from the holding part, the button is provided with a locking rod penetrating the holding part, and the locking rod is provided with a locking block; when the limiting structure is in the unlocking position, the locking block is staggered from the plurality of limiting openings; sand when the limiting structure is in the locking position, the locking block is embedded in one of the plurality of limiting openings.

14. The knife as claimed in claim 13, wherein an elastic member is disposed between the locking rod and the holding part, and an elastic force supplied to the locking rod by the elastic member makes the locking block be embedded in the one of the plurality of limiting openings.

15. The knife as claimed in claim 3, wherein each of the plurality of limiting openings is a limiting groove with an opening.

16. The knife as claimed in claim 15, wherein the limiting structure comprises a locking member hanged with the holding part, and one end of the locking member is provided with a locking hook; when the limiting structure is in the locking position, the locking, hook is separated from the plurality of limiting grooves; and when the limiting structure is in the unlocking position, the locking hook is embedded in one limiting groove.

17. The knife as claimed in claim 16, wherein an elastic member is disposed between the locking member and the holding part, and an elastic force supplied to the locking member by the elastic member makes the locking hook be embedded in the one limiting groove.

18. The knife as claimed in claim 17, wherein the elastic member is located at one end of the locking member away from the locking hook.

19. The knife as claimed in claim 16, wherein limiting grooves corresponding to the plurality of limiting openings are of a toothed shape formed by a plurality of toothed grooves.

20. The knife as claimed in claim 19, wherein the locking hook comprises a plurality of locking teeth matching toothed grooves corresponding to the plurality of limiting grooves.

21. The knife as claimed in claim 1, wherein the holding part comprises a handle, the cutting part comprises a blade, the handle comprises a first casing and a second casing that are detachably connected, and the bladed is clamped between the first casing and the second casing.
